(19) United States
(12) Patent Application Publication
(10) Pub. No.: US 2018/0062227 A1
(43) Pub. Date: Mar. 1, 2018

(54) Energy Storage Apparatus for a Motor Vehicle and a Motor Vehicle

(71) Applicant: AUDI AG, Ingolstadt (DE)

(72) Inventors: Christian OEDBAUER, München (DE); Michael FRAUENHOFER, Aichach (DE); Thomas WEISS, Böhmfeld (DE)

(73) Assignee: AUDI AG, Ingolstadt (DE)

(21) Appl. No.: 15/684,328

(22) Filed: Aug. 23, 2017

(30) Foreign Application Priority Data
Aug. 23, 2016 (DE) 10 2016 215 839.2

(51) Int. Cl. H01M 10/6556; B60L 11/18; H01M 10/625; H01M 10/613; H01M 10/615; H01M 10/63; H01M 2/10

(52) U.S. Cl. CPC H01M 10/6556; B60L 11/187; H01M 10/625; H01M 2220/20; H01M 10/615; H01M 10/63; H01M 2/1077; H01M 10/613

(57) ABSTRACT

An energy storage apparatus for a motor vehicle. A carrier element, a plurality of energy storage devices attached on one side of the carrier element and a temperature control device arranged on the other side of the carrier element that is thermally coupled with the energy storage devices. The temperature control device is provided with one or multiple temperature control sections, wherein each respective temperature section is a pipe or a hose having at least on fluid channel built for conducting a temperature control fluid.

### FIELD

The invention relates an energy storage apparatus for a motor vehicle comprising a carrier element, a plurality of energy storage devices attached on one side of the carrier element and a temperature control device arranged on the other side of the carrier element which is thermally coupled to the temperature control element.

### BACKGROUND

Energy storage apparatuses that are provided with several storage device to supply electricity to electrically driven motor vehicles must as a rule have their temperature actively controlled, in particular cooled, due to the high currents that they provide. Extreme temperature control, wherein a temperature control device is arranged on a side of a carrier plate arranged opposite the energy device, is preferred in this case over internal temperature control because the temperature control fluids that may flow out in case of a fault cannot cause any damage to the energy storage device. Several constructive approaches are known for guiding such temperature control fluids within the temperature control device.

From WO 2013/139908 A1 is known a battery for a motor vehicle, wherein a cooling plate having semicircular lines for a coolant which is open on one side is attached directly to a housing wall. However, since the housing wall is in direct contact with the coolant, the housing wall can be over time affected by corrosion.

DE 10 2014 203 765 A1 discloses a structural module provided with an energy storage device module and with a flat cooling element, wherein a contact side of the energy storage device module is permanently materially bonded in a dimensionally stable manner to the contact side of the cooling element in such a manner that the energy storage device module and the cooling element create a structural module. The cooling element is a cooling plate provided with cooling channels in which a cooling fluid can flow.

Furthermore, DE 10 2011 104 433 A1 discloses an energy storage device module provided with a holding plate and with a cell module attached to it, wherein a main body of the holding plate is thermally connected to the cell module and provided with at least one fluid channel integrally formed in the main body. The main body is connected by means of heat conducting adhesive bonding to the cell module in order to exchange thermal energy between the fluid and the cell module.

However, both last-mentioned elements that are provided with integrated cooling channels are very heavy, which is undesirable from the viewpoint of integration in a motor vehicle.

### SUMMARY OF THE DISCLOSURE

The object of the invention is therefore to provide an energy storage device which is improved in comparison.

This object is achieved according to the invention with an energy storage device of the type mentioned in the introduction in which the temperature control device is provided with one temperature control section or with a plurality of temperature control sections, wherein the or each respective temperature control section is a tube or a hose having at least one fluid conducting channel designed for conducting a temperature control fluid.

The invention is based on the realization that it is possible to form an energy storage device that is thermally coupled to a temperature control device comprising one or several separate temperature control sections formed with a tube or a hose so that on the one hand, the temperature control fluid can be fully enclosed, while on the other hand, massive cooling plates with inner channels can be avoided. A contact of the carrier element with the temperature control fluid is thus advantageously avoided in this manner while a temperature control device that has a particularly low weight is realized at the same time.

The tube or the hose may have a circular, oval or polygonal cross-section. It is particularly preferred when the tube or the hose has two parallel sides viewed in cross-section, which are connected to each other by curved walls, in particular when the temperature controlling element or each temperature controlling element is designed as a flat tube. The tube or the hose can be further in the cross-section provided with a constant wall thickness in its circumference. A pipe is characterized by an intrinsic stability. A hose is in particular reversibly bendable. Under a fluid conducting channel is to be understood a continuous space inside the type or the hose through which the temperature controlling fluid can flow.

The or each temperature controlling section can be further arranged directly on the side facing away from the carrier, in particular attached to it. An individual temperature controlling section can be designed essentially so that it extends straight, i.e. without curvatures, along the carrier element. The energy storage device according to the invention is typically designed to provide electric energy to a drive device of a motor vehicle. In particular, an output voltage of at least 60 V, in particular of at least 150 V, can be provided by the energy storage device. The energy storage device can be therefore regarded as a high-voltage battery.

In the case of the energy storage device according to this invention it is preferred when the or each temperature control section is arranged in a groove on the side of the carrier element. This makes it possible to couple thermally a greater part of the surface of the or of each temperature control section via the carrier element to the energy storage device. In particular, this also means that the groove can be inserted so deep in the carrier element that the respective temperature control section is mounted flush in the carrier element.

According to a particularly advantageous embodiment, the or each temperature control section is attached to the carrier element by means of an adhesive. This makes it possible to avoid mechanically complex fastening with screws, latches and the like, and in addition, the additional weight of such fastening elements is also avoided. There are also additional advantages of such a package relating to the energy storage device provided in the motor vehicle, because an adhesive connection can be realized in a substantially more space-saving manner than in the case of a connection by means of fastening elements. In order to realize such an adhesive connection, the carrier plates and the temperature controlling sections only need to be cleaned in advance. After the application of the adhesive, a firm connection with the carrier element can be achieved by briefly applying pressure and raising temperature (for example for 2 minutes at 100° C.).

The adhesive can comprise a base material creating the adhesive effect and an additive having a higher thermal conductivity than the base material. With such an adhesive, additional gap fillers, such as heat conducting pastes which are typically used to compensate for gaps due to surface tolerances with a thermally conductive coupling, can be dispensed with. The base material is based for example on an epoxy resin or polyurethane. These base substances have already proven effective as one-component or two-component adhesives in car body constructions. The filler creates a modification of heat conduction, which significantly increases the thermal conductivity of the adhesive.

In addition, it is preferred if the adhesive fully covers the or a temperature control section on the side of the carrier element. A particularly large area of the thermal coupling can thus be created between the or each temperature control section and the carrier element. Accordingly, this improves also indirect thermal coupling with the energy storage devices. In particular when the or each temperature control section is fixed in a groove, the groove can be fully lined with the adhesive.

It is further preferred when the or each temperature section of the energy storage device according to the invention is provided with multiple parallel fluid channels in its interior. The temperature control fluid can thus be guided free of turbulence through the or through each of the respective temperature control sections. In particular when a flat pipe is used for a temperature control section, a plurality of parallel fluid channels can be realized between the flat sides of the separation walls extending over the temperature control section.

It is expedient when the temperature control sections extend, in particular in a flow direction of the temperature control fluid, parallel to each other. The temperature control sections can be also arranged at a distance from each other. Furthermore, the temperature control section can extend from one lateral edge to a lateral edge on the other of the carrier element.

It is further preferred when the temperature sections of the energy storage device according to the invention are connected by means of a pair of circuits comprising a feed line and a return line. Temperature fluid can be supplied with such a fluid-mechanical parallel circuit to each temperature control section via the feed line as an unused fluid, which is to say a fluid that is not yet warmed up, or not yet cooled temperature control fluid. It is preferred when the feed line and/or the return line are deployed so that they are arranged on the edge of the carrier element.

In this case it is particularly preferred when the pair of circuits is provided with a plurality of partial lines connected to each other to which at least one temperature control section is attached in a fluid-conducting manner. A partial line is thus provided with a feed line section and with a return line section, so that a temperature control section or several temperature control sections arranged parallel to each other are provided between them. The temperature control device can thus be formed with several partial line pair which are mutually connected to each other and which are provided as modules for constructing temperature control devices having different sizes. Adjacent partial line sections are preferably soldered to one another.

As an alternative to the parallel circuit described above, the temperature control sections can be connected in series to multiple connection lines. In this case. the temperature control fluid passes through each temperature control section one after another so that a meandering flow path of the temperature control fluid along the carrier element can be realized.

Further, the energy storage device according to the invention can be provided with a housing enclosing the energy storage device, wherein the carrier element is designed as a housing wall of the housing. The carrier element can be in this respect designed as a base plate of the housing which spatially separates, in particular with the fluid-tight, enclosed housing, the energy storage from the temperature control device and prevents penetration of the temperature control fluid into the housing. The housing is preferably formed from aluminum. Since the energy storage devices can be thermally coupled via the carrier element also to the housing, the housing creates with its thermal capacity an additional thermal buffer for temperature control, in particular for cooling of the energy storage device.

Finally, it is preferred when the energy storage device according to the invention is provided with a conveying device which is designed for conveying the temperature control fluid along the temperature control element, and which includes a control device used to activate the conveying device as a function of at least one thermal load based on load information describing the energy storage device. The control device can be designed to activate the conveying device only when a threshold value is reached based on the load information. The load information can use the temperature of the energy storage device and/or of the energy storage apparatus and/or the output provided by the energy storage apparatus and/or the amount of energy and/or the time elapsed since an activation of the motor vehicle provided with the energy storage device by means of the drive device. In particular, with respect to the fact that a housing is provided, the thermal capacity of the housing can be at first used for temperature control of the energy storage device so that activation of the conveying device for temperature control occurs only when a threshold value is reached. The operations requiring a high output of the conveying device can thus be reduced in this manner.

The invention also relates to a motor vehicle comprising an energy storage apparatus according to the invention configured for providing electric energy to at least one motor vehicle component. It is preferred when the motor vehicle component is an electric drive device which is designed for complete and/or auxiliary support of the drive of the motor vehicle.

All the embodiment of the energy storage device according to the invention can be applied analogously also to the motor vehicle according to the invention, so that the advantages described above can be achieved also with these embodiments.

### BRIEF DESCRIPTION OF THE DRAWINGS

Further advantages and details of the invention will become apparent from the embodiments described below and in the attached drawings. The drawings are schematic illustrations which show the following:

FIG. 1 shows a principle diagram of an embodiment of a motor vehicle according to the invention with an energy storage apparatus according to the invention;

FIG. 2 shows an exploded view of a carrier element and of a temperature control device of the energy storage apparatus shown in FIG. 1;

FIG. 3 shows a cross-section through the energy storage apparatus shown in FIG. 2; and

FIG. 4 shows a carrier element and the temperature control device in the mounted state.

### DETAILED DESCRIPTION

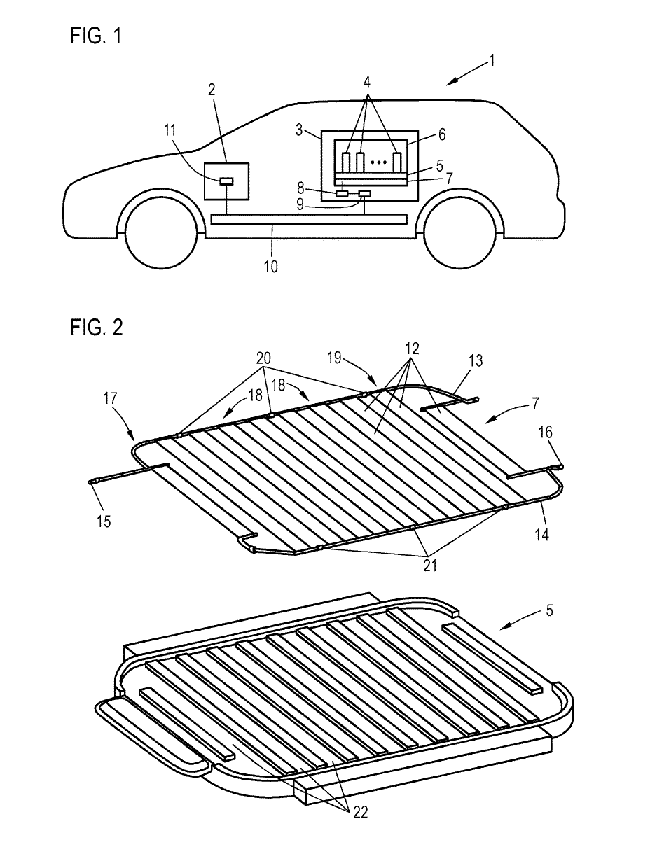

FIG. 1 shows a principle diagram of an embodiment of a motor vehicle 1 comprising a drive device 2, which is designed to enable a complete or supported drive operation of the motor vehicle 1 and to which electricity is supplied with an energy storage apparatus 3.

The energy storage device apparatus 3 is equipped with a plurality of energy storage devices 4, for example in the form of energy storage device modules on the lithium-ion basis, which together provide a voltage of for example 200 Volts for the drive device 2. The energy storage devices 4 are mechanically attached to a carrier element 5 and they are thermally coupled to it. The carrier element 5 forms the base plate of a housing 6 accommodating energy storage devices 4, which is formed from aluminum. On the side facing away from the energy storage devices of the carrier element 5 is arranged a temperature control device 7, which cools or heats the energy storage devices on a thermal path via the carrier element 5 as needed by means of a temperature control fluid.

In addition, the energy storage apparatus 3 is provided with a conveying device 8 for conveying the temperature controlling fluid, which can be controlled by means of a control apparatus 9, for example in the form of a control device. This device is connected via a motor vehicle bus 10 to a control device 11 of the drive device 2 and to other motor vehicle components, not shown here.

FIG. 2 shows an exploded view of an illustration of the carrier element 5 and of the temperature control device 7 with a view of the side of the carrier element 5 turned away from the energy storage devices 4.

The temperature control device 7 is provided with temperature control sections 12 that extend parallel in a plane in the transverse direction of the carrier element 5, which are formed respectively as flat tubes. According to other embodiments, the temperature control sections 12 can be also formed differently, namely as a differently formed tube or hose, for example with a circular, oval or polygonal cross-section.

The temperature control sections 12 are further also fluidically connected in parallel by means of a feed line 13 and a return line 14. The conveying device 8 pumps the temperature control fluid for example via a hose line, not shown here, into an inlet 15, so that it is distributed from there along the feed line 13 over all of the temperature control sections 12 to arrive via the return line 14 to an outlet 16. On the other side of the outlet 16, the temperature control fluid is conducted to a temperature control fluid tank which is connected with the conveying device 8, whereby the temperature control fluid circuit is closed.

The temperature control device 7 has a modular design and it comprises an inlet segment 17 provided with an inlet 15 and two temperature control sections 12, two main segments 18 with respective three temperature control section 12 and an outlet segment 19 comprising an outlet 16 and temperature control sections 12. The feed line 13 and the return line 14 are subdivided in each of these segments into a pair of partial lines to which the respective temperature control sections 12 are attached in a fluidically conductive manner. Each partial line pair is pushed into one another at connection points 20, 21 and fastened to each other with flame soldering. The temperature sections 12 are also soldered to slot-like recesses of the feed line 12 and of the return line 14. The size of the temperature control device 7 can be scaled by adding or leaving out main segments 18 so that suitable temperature devices 7 can be built for a plurality of carrier geometries.

The carrier element is provided in the example shown with eleven grooves 22 into which the temperature sections 12 are inserted flush. The temperature sections 12 are covered on the entire surface in the grooves with an adhesive, which in addition to having an adhesive effect realized with the basic substance, for instance with an epoxy resin or polyurethane, comprises also an additive that has a higher conductivity than the basic substance. The adhesive substance therefore fills up—similarly to a conventional heat-conducting paste—the gaps between the carrier element 5 and the temperature control sections 12 and at the same time it is also used for mechanical fastening.

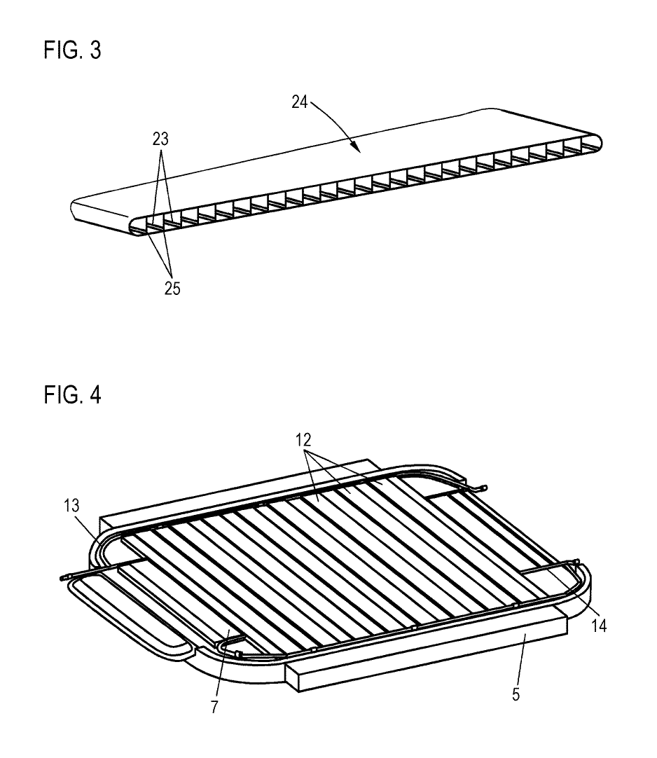

FIG. 3 shows a cross-section through a temperature control section 12 of the temperature control device 7. Each of the temperature control sections 12 is provided with several fluid channels 23, for example 28, which are separated from each other by partition walls 25 extending perpendicularly to the flat sides 24 of each temperature control section 12. The fluid channels 23 have in this case a cross-section of approximately 2.04×2.68 mm with a wall thickness of 0.3 mm of the flat tube and of the partition wall 25. Each temperature section 25 is accordingly about 75 mm wide. The temperature sections are designed with an aluminum extrusion profile in order to realize their filigree structure. Overall, the temperature control device 7 has external dimensions of approximately 1.3×2.1 m². The diameter of the feed line 13 and that of the return line 14 is 13 mm, respectively.

FIG. 4 shows the carrier element 5 and the temperature control device 7 in the mounted state. The temperature control sections 12 enclose the grooves 22 flush which are covered as shown in FIG. 4, wherein the feed line 13 and the return line 14 are deployed on the side at the edge of the carrier element 5.

The temperature control device 7 can thus be thermally coupled via the carrier element 5 to the energy storage devices 4 (see FIG. 1) with the activation of the conveying device 8 by means of the control device 9 for a temperature control function, in particular for cooling during the operation. With the coupling of the energy storage device 4 by the carrier element 5 and thus also by the entire housing 6, the heat generated in addition during the operation of the energy storage apparatus 3 can be buffered with the intrinsic heat capacity of the housing.

In particular, during the travel of the motor vehicle 1 over a short distance, an activation of the conveying means 8 can be dispensed with because the heat capacity of the housing 6 can be used first for heat removal. The control device 9 is accordingly designed to activate the conveying device 8 only when a thermal load describing the load information of the energy storage device 2 has at least exceed a predetermined threshold value. The load information can for example describe a temperature of the energy storage device 4 or of the energy storage apparatus 3, the output provided from the energy storage apparatus 3, an energy amount, the time duration of the operation of the drive device 2, or a combined value may be described. The load information can be in this case determined with data that is transmitted via the motor vehicle bus 10.

According to a further embodiment of the motor vehicle 1, the temperature sections 12 are not connected fluidically in parallel, but instead they are connected by means of several connection lines in series. This means that the temperature control fluid passes through the temperature control sections 12 one after another. As a result, a meander-like structure of the temperature control device 7 can be realized in particular.

1. An energy storage apparatus for a motor vehicle, comprising:
a carrier element, a plurality of energy storage devices attached on one side of the carrier element and a temperature control device arranged on the other side of the carrier element, thermally coupled with the energy storage devices, wherein the temperature control device is provided with a temperature control section or with a plurality of temperature control sections, wherein each respective temperature control section is designed as a tube or as a hose having at least one fluid channel for conducting a temperature control fluid.

2. The energy storage device according to claim 1, wherein each respective temperature control section is arranged in a groove on the side of the carrier element.

3. The energy storage device according to claim 1, wherein each respective temperature section is attached by an adhesive to the carrier element.

4. The energy storage device according to claim 3, wherein the adhesive including a base substance for realizing an adhesive effect and an additional substance that has a higher thermal conductivity compared to the base substance.

5. The energy storage device according to claim 3, wherein the adhesive fully covers the temperature section on the carrier element side.

6. The energy storage device according to claim 1, wherein each respective temperature section is provided in its interior with a plurality of fluid conducting channels.

7. The energy storage device according to claim 1, wherein the temperature control sections extend in parallel to each other.

8. The energy storage device according to claim 1, wherein the temperature control sections are connected in parallel by means of a feed line and a return line having a line pair, or by several lines connected in series.

9. The energy storage device according to claim 1, wherein a plurality of mutually connected line pairs are arranged on each other, upon which is respectively provided at least one conductive temperature control section in a fluidically conductive manner.

10. The energy storage device according to claim 1, wherein a housing is provided which houses the energy storage devices, wherein the carrier element is designed as a housing wall of the housing.

11. The energy storage device according to claim 1, wherein a conveying device, which is designed for conveying the temperature fluid along the temperature control element, and a control device is provided, which is designed for an activation of the conveying device as a function of at least one load information item describing the thermal load of the energy storage apparatus.
